(19) United States
(12) Patent Application Publication
(10) Pub. No.: US 2025/0232911 A1
(43) Pub. Date: Jul. 17, 2025

(54) LENS DRIVE DEVICE AND CAMERA MODULE

(71) Applicant: ALPS ALPINE CO., LTD., Tokyo (JP)

(72) Inventors: Tetsuharu OGINO, Miyagi (JP); Wataru OGUCHI, Miyagi (JP)

(21) Appl. No.: 19/014,807

(22) Filed: Jan. 9, 2025

(30) Foreign Application Priority Data
Jan. 16, 2024 (JP) 2024-004463

(51) Int. Cl. H01F 27/30; G02B 7/09; G03B 13/36; G03B 17/12

(52) U.S. Cl. CPC H01F 27/306; G02B 7/09; G03B 13/36; G03B 17/12

(57) ABSTRACT

A lens drive device that includes a lens holder; a support; a coil member; and a first magnet and a second magnet. The lens holder includes a first holding portion; a second holding portion; a first coil arrangement surface; a second coil arrangement surface; a relay surface; first coil support portions; and second coil support portions. The first coil support portions include a first support projection; a second support projection; and an intermediate support projection provided between the first support projection and the second support projection. The first coil is wound around the first coil support portions with a portion bent to one side in the extending direction as a winding-start end of a first turn, and a base of the second support projection is provided with a protruding portion located on an extension line of the first annular wire portion extending from the winding-start end of the first turn.

### CROSS-REFERENCE TO RELATED APPLICATIONS

The present application is based on and claims priority to Japanese Patent Application No. 2024-004463 filed on Jan. 16, 2024, the entire contents of which are hereby incorporated by reference.

### BACKGROUND

### 1. Field of the Invention

The present disclosure relates to a lens drive device mounted on, for example, a portable device with a camera, and a camera module including the lens drive device.

### 2. Description of the Related Art

Conventionally, there has been known a lens drive device in which a lens holder is moved along an optical-axis direction by a driver that includes a coil wound around coil support portions projecting outward from a side surface of the lens holder in a radial direction of a circle centered on the optical axis and a magnet attached to a fixed-side member (see International Publication No. WO2018/043132). In such lens drive device, the coil has a coil axis perpendicular to the optical-axis direction and is configured to include a plurality of winding layers. Each winding layer is configured to include a plurality of turns of annular wire portions wound around the coil support portions.

### SUMMARY

A lens drive device according to an embodiment of the present disclosure includes: a lens holder capable of holding a lens body; a support configured to movably support the lens holder in the optical-axis direction; a coil member provided in the lens holder and formed of continuous wire including a first coil, a second coil, and a relay portion serially connecting the first coil and the second coil; and a first magnet facing the first coil and a second magnet facing the second coil, wherein the lens holder includes: a first holding portion configured to hold one end portion of the wire; and a second holding portion configured to hold the other end portion of the wire; a first coil arrangement surface provided on one surface of two outer surfaces of the lens holder facing each other across the optical axis; and a second coil arrangement surface provided on the other surface of the two outer surfaces, a relay surface provided between the first coil arrangement surface and the second coil arrangement surface and facing the relay portion; first coil support portions projecting outwardly from the first coil arrangement surface and wound with a first annular wire portion constituting the first coil; and second coil support portions projecting outwardly from the second coil arrangement surface and wound with a second annular wire portion constituting the second coil; wherein the first coil support portions include: a first support projection; a second support projection; and an intermediate support projection provided between the first support projection and the second support projection, that are arranged side by side apart from each other in an extending direction perpendicular to the optical-axis direction of the first annular wire portion. The first coil is wound around the first coil support portions with a portion where the wire extending from the first holding portion is bent to one side in the extending direction at the first support projection or the intermediate support projection as a winding-start end of the first turn, and a base of the second support projection is provided with a protruding portion located on an extension line of the first annular wire portion extending from the winding-start end of the first turn.

### BRIEF DESCRIPTION OF THE DRAWINGS

FIG. 1 is an exploded perspective view of a camera module;

FIG. 2 is an exploded perspective view of a lens drive device;

FIG. 3 is an upper perspective view of a lens drive device with some components removed;

FIG. 4 is an upper perspective view of a lens holder;

FIG. 5 is a lower perspective view of the lens holder;

FIG. 6 is front and bottom views of the lens holder;

FIG. 7 is rear and bottom views of the lens holder;

FIG. 8 is a bottom view of the lens drive device with some components removed;

FIG. 9 is a figure illustrating an example of a connection structure between a plate-spring holder, a yoke, and an upper plate spring;

FIG. 10 is bottom and front views of the lens holder, a coil member, and a lower plate spring;

FIG. 11 is an upper perspective view of a metal member and a base member;

FIG. 12 is front views of lens holders;

FIG. 13 is front views of the lens holders and coil members;

FIG. 14 is a front view, a left-side view, a right-side view, a top view, and a bottom view of a left-front support projection;

FIG. 15 is a partial cross-sectional view of the lens holder and the coil member;

FIG. 16 is a partial cross-sectional view of the lens holder and the coil member; and

FIG. 17 is a figure illustrating another configuration example of the lens holder.

### DETAILED DESCRIPTION OF THE DISCLOSURE

In the above-described lens drive device, when countermeasures against winding disorder of the wire constituting the coil are not taken, a space is formed between the annular wire portion of the first turn and the surface of the lens holder in the transition part for transition from the first turn to the second turn of a first layer, which is an innermost layer of the plurality of winding layers, and there is a risk that winding disorder of the wire forming the coil occurs when other annular wire portions (for example, the annular wire portion of a second layer) enter the space.

Therefore, it is desirable to provide a lens drive device capable of suppressing the occurrence of winding disorder of the wire constituting the coil.

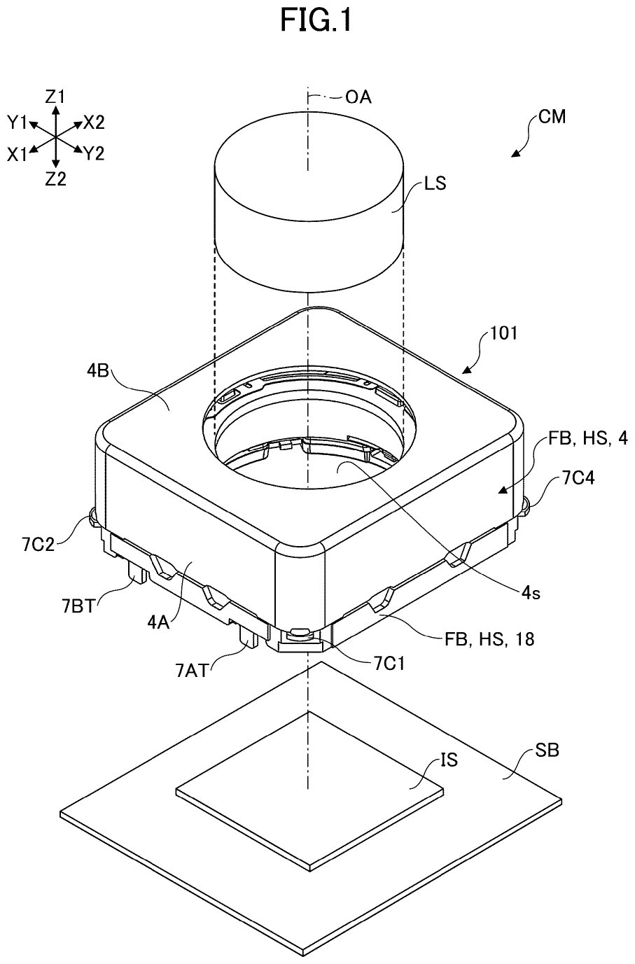

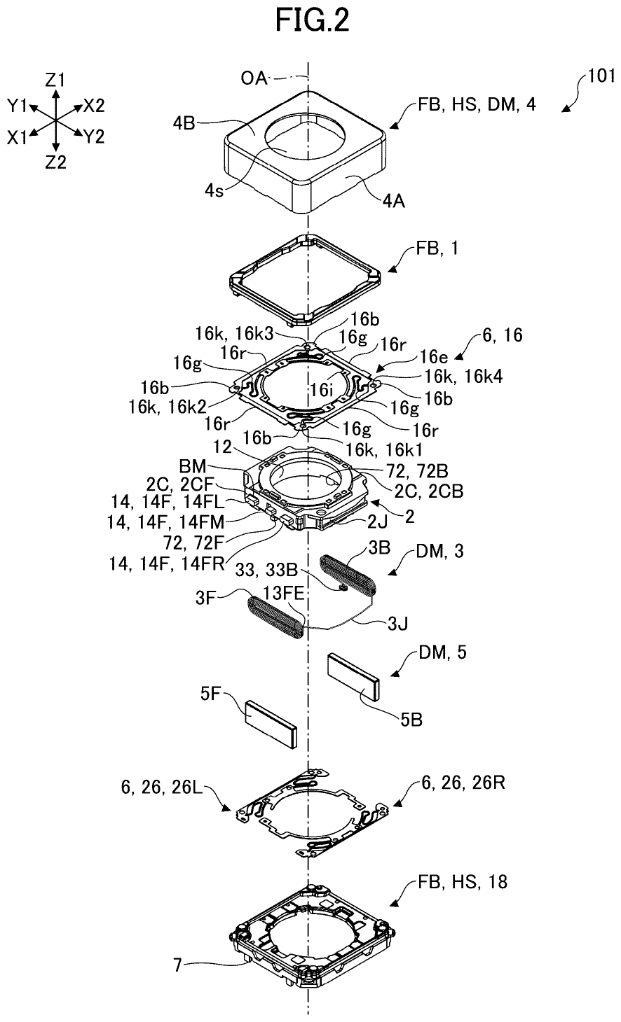

A camera module CM and a lens drive device 101 according to an embodiment of the present disclosure will be described in the following with reference to the drawings. FIG. 1 is an exploded perspective view of the camera module CM, and FIG. 2 is an exploded perspective view of a lens drive device 101 constituting the camera module CM. In FIG. 1, X1 represents one direction of an X-axis constituting a three-dimensional orthogonal coordinate system, and X2 represents the other direction of the X-axis. Y1 represents one direction of a Y-axis constituting a three-dimensional orthogonal coordinate system, and Y2 represents the other direction of the Y-axis. Similarly, Z1 represents one direction of a Z-axis constituting the three-dimensional orthogonal coordinate system, and Z2 represents the other direction of the Z-axis. In FIG. 1, an X1 side of the camera module CM corresponds to the front side of the camera module CM, and an X2 side of the camera module CM corresponds to the rear side of the camera module CM. A Y1 side of the camera module CM corresponds to the left side of the camera module CM, and a Y2 side of the camera module CM corresponds to the right side of the camera module CM. A Z1 side of the camera module CM corresponds to the upper side (subject side) of the camera module CM, and a Z2 side of the camera module CM corresponds to the lower side (image sensor side) of the camera module CM. The same applies to other members and other figures.

As illustrated in FIG. 1, the camera module CM includes a substrate SB, a lens drive device 101, a lens body LS, and an image sensor IS mounted on the substrate SB so as to face the lens body LS. The lens body LS is, for example, a cylindrical lens barrel provided with at least one lens, and is configured such that its center axis is along the optical-axis direction. The optical-axis direction includes a direction of an optical axis OA with respect to the lens body LS and a direction parallel to the optical axis OA.

As illustrated in FIG. 2, the lens drive device 101 includes a lens holder 2 capable of holding the lens body LS, a driver DM for moving the lens holder 2 along the optical-axis direction (Z-axis direction), a plate spring 6 as a support for supporting the lens holder 2 movably in the optical-axis direction, a fixed-side member FB to which the plate spring 6 is fixed, and a metal member 7 functioning as a conductive member for electrically connecting an external power source with the lens drive device 101.

As illustrated in FIG. 2, the driver DM includes a coil member 3 attached to the lens holder 2, a yoke 4 as a cover member which also functions as a bottomless box-like outer case having a substantially rectangular outer shape in a top view, and a pair of magnets 5 arranged so as to face front and rear surfaces of the yoke 4. In the illustrated example, the magnets 5 are bipolar permanent magnets and include a front magnet 5F and a rear magnet 5B. The fixed-side member FB includes a plate-spring holder 1, the yoke 4, and a base member 18 in which the metal member 7 is embedded.

The plate spring 6 includes an upper plate spring 16 arranged between the plate-spring holder 1 and the lens holder 2, and a lower plate spring 26 arranged between the lens holder 2 and the base member 18. The lower plate spring 26 includes a left lower plate spring 26L and a right lower plate spring 26R.

As illustrated in FIG. 1, the lens drive device 101 has a substantially rectangular parallelepiped shape and is mounted on the substrate SB on which an image sensor IS is mounted.

The coil member 3 is connected to a power supply via the lower plate spring 26, the metal member 7, and the substrate SB. When a current flows through the coil member 3, the driver DM generates an electromagnetic force along the optical-axis direction.

The lens drive device 101 uses this electromagnetic force to achieve an automatic focusing function by moving the lens holder 2 along the optical-axis direction on the Z1 side (subject side) of the image sensor IS. Specifically, the lens drive device 101 moves the lens holder 2 away from the image sensor IS to enable macro photographing, and moves the lens holder 2 closer to the image sensor IS to enable infinity focus photographing.

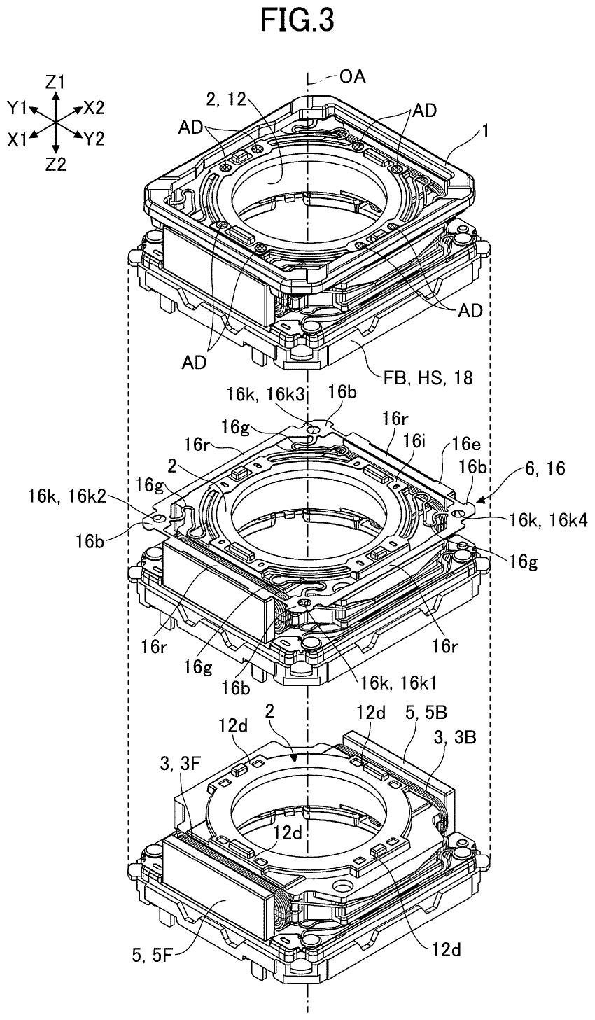

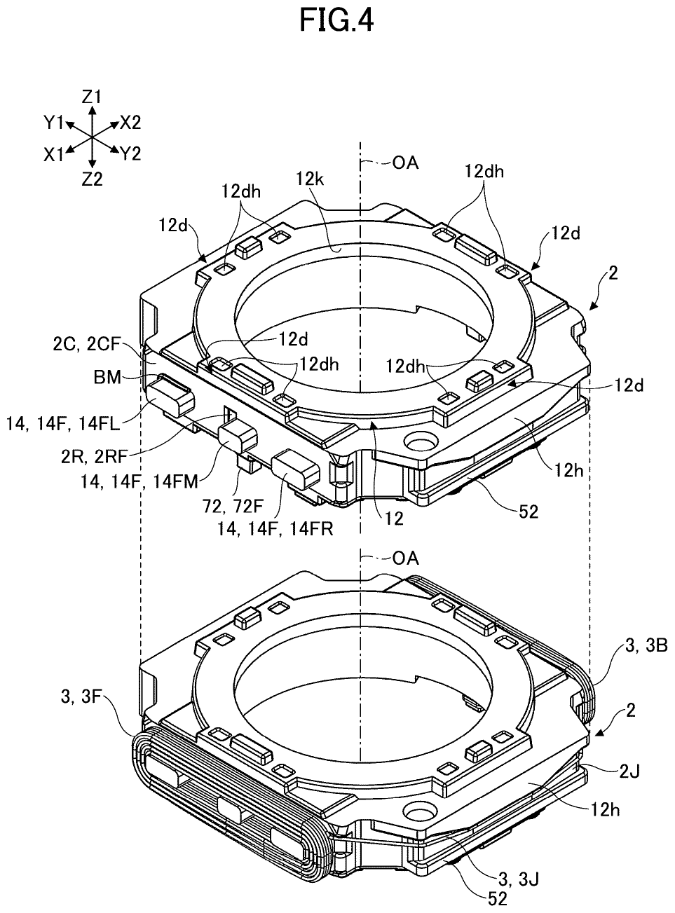

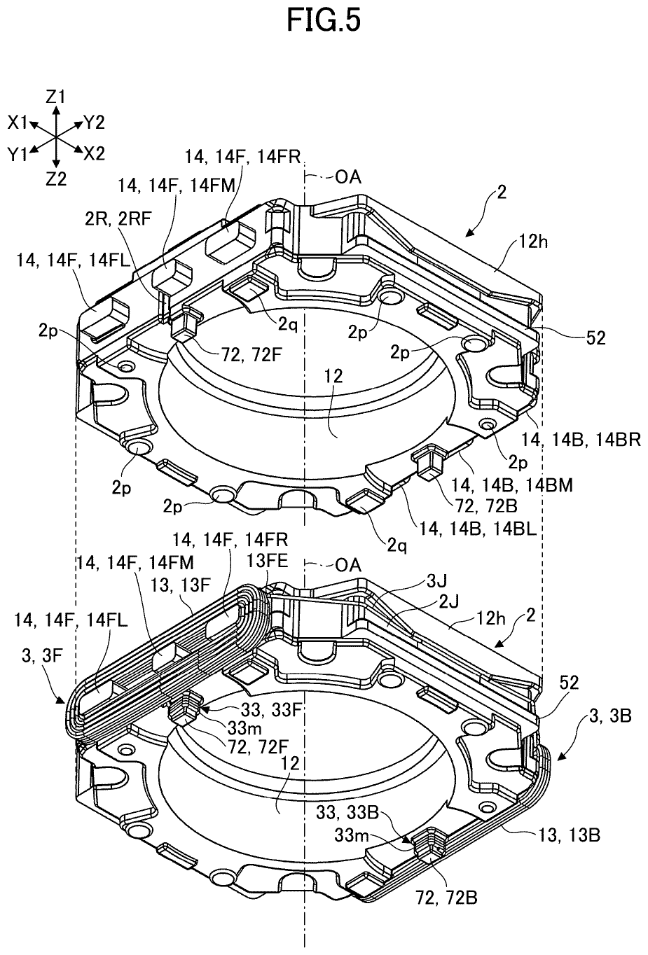

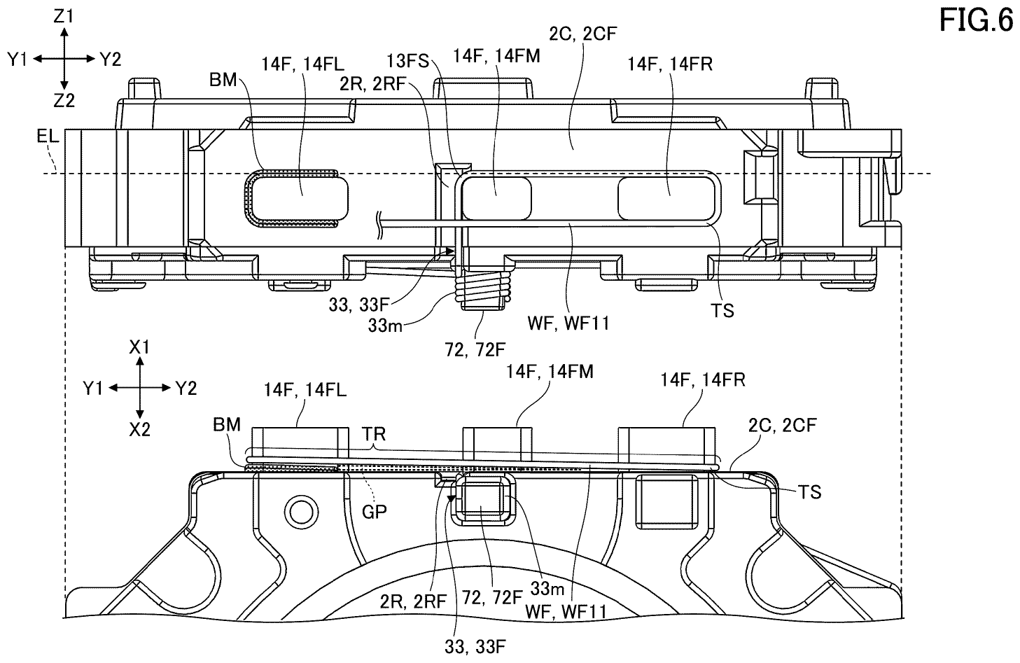

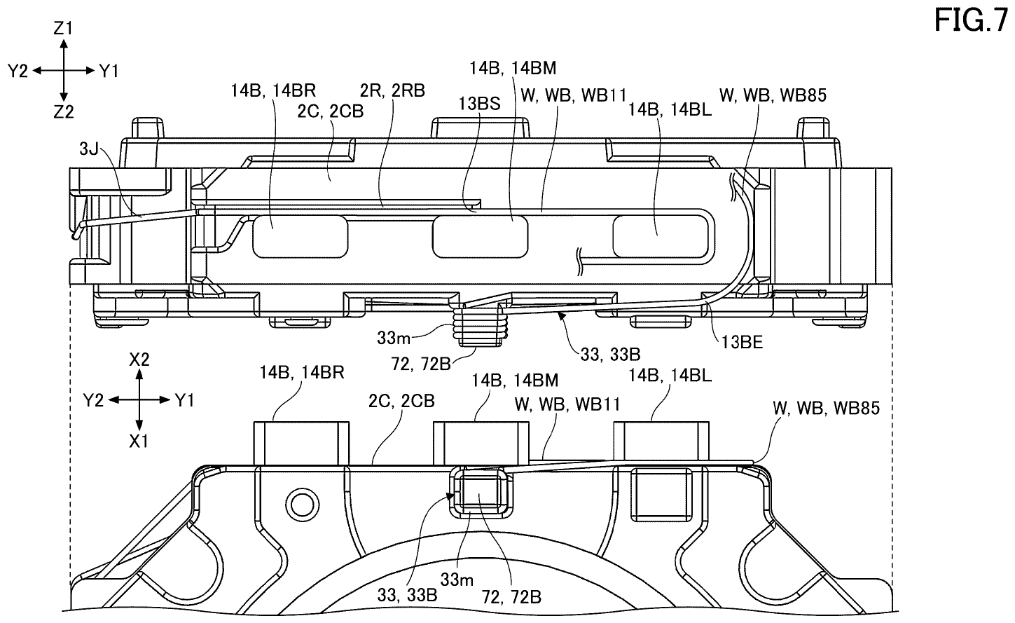

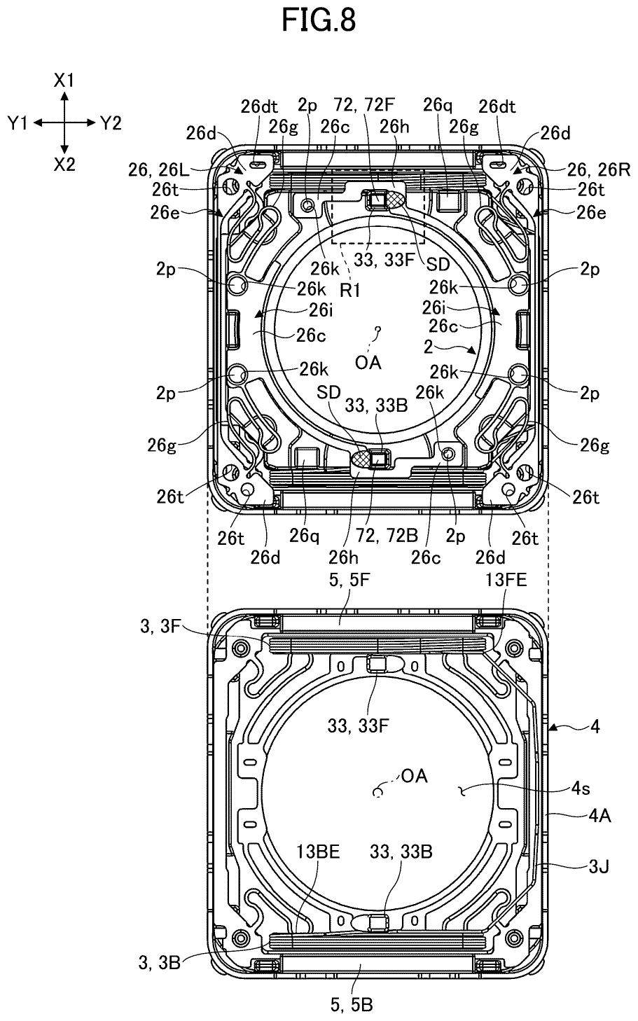

Next, a positional relationship between the lens holder 2 and the driver DM will be described with reference to FIGS. 3 to 8. FIG. 3 is an upper perspective view of the lens drive device 101 in a state where some of the components are removed. Specifically, an upper figure of FIG. 3 is an upper perspective view of the lens drive device 101 in a state where the yoke 4 is removed. A center figure of FIG. 3 is an upper perspective view of the lens drive device 101 in a state where the plate-spring holder 1 is removed, and a lower figure of FIG. 3 is an upper perspective view of the lens drive device 101 in a state where the upper plate spring 16 is removed. FIG. 4 is an upper perspective view of the lens holder 2, and FIG. 5 is a lower perspective view of the lens holder 2. Specifically, an upper figure of FIG. 4 and an upper figure of FIG. 5 illustrate the lens holder 2 in which the coil member 3 is not wound, and a lower figure of FIG. 4 and a lower figure of FIG. 5 illustrate the lens holder 2 in which the coil member 3 is wound. FIG. 6 is a front view of the lens holder 2 and a bottom view of a front portion of the lens holder 2. FIG. 7 is a rear view of the lens holder 2 and a bottom view of a rear portion of the lens holder 2. FIG. 8 is a bottom view of the lens drive device 101 in a state in which some of the components are removed. Specifically, an upper figure of FIG. 8 is a bottom view of the lens drive device 101 in a state in which the metal member 7 and the base member 18 are removed, and a lower figure of FIG. 8 is a bottom view of the lens drive device 101 in a state in which the lower plate spring 26 and the lens holder 2 are removed.

The plate-spring holder 1 is arranged so as to prevent the lens holder 2 from colliding with the yoke 4 when the lens holder 2 is moved in a Z1 direction. That is, the plate-spring holder 1 functions as a spacer member and is arranged so as to form a space between the lens holder 2 and an upper surface portion 4B of the yoke 4. However, when a space can be formed between the lens holder 2 and the upper surface portion 4B of the yoke 4 by another member or structure, the plate-spring holder 1 may be omitted. In the illustrated example, the plate-spring holder 1 is made by injection molding a synthetic resin such as a liquid crystal polymer (LCP).

The lens holder 2 is made by injection molding a synthetic resin such as a liquid crystal polymer (LCP). Specifically, as illustrated in FIG. 4, the lens holder 2 includes a cylindrical portion 12 formed to include an opening 12k which is a through-hole along the optical-axis direction, and a projecting portion 52 formed at an end of an image sensor IS side (Z2 side) in the optical-axis direction. The cylindrical portion 12 is formed to be substantially cylindrical at an end of a subject side (Z1 side) in the optical-axis direction.

The lens body LS is configured to be fixed to the inside of the cylindrical portion 12 by using an adhesive. A helical groove may be provided on an inner peripheral surface of the cylindrical portion 12. This is to enhance the adhesive strength between the lens body LS and the cylindrical portion 12. On an end surface of the cylindrical portion 12 on the subject side, four pedestal portions 12d having recesses 12dh are provided so as to surround the optical axis OA. As illustrated in FIG. 3, an inner portion 16i of the upper plate spring 16 is placed on the pedestal portions 12d.

As illustrated in the upper figure of FIG. 4, coil support portions 14 for supporting the coil member 3 from the inside are provided on an outer peripheral surface of the cylindrical portion 12. In the illustrated example, the coil support portions 14 are formed so as to support the substantially rectangular annular coil member 3. At the end of the lens holder 2 on the subject side, an eave portion 12h projecting radially outward is formed so as to face the projecting portion 52 in the optical-axis direction.

Specifically, as illustrated in the upper figure of FIG. 5, the coil support portions 14 include front coil support portions 14F and rear coil support portions 14B, and the coil member 3 includes a front coil 3F and a rear coil 3B, as illustrated in the lower figure of FIG. 5. More specifically, the front coil support portions 14F include a front-left support projection 14FL, a front-center support projection 14FM, and a front-right support projection 14FR, and the rear coil support portions 14B include a rear-left support projection 14BL, a rear-center support projection 14BM, and a rear-right support projection 14BR. In the illustrated example, the front-left support projection 14FL, the front-center support projection 14FM, the front-right support projection 14FR, the rear-left support projection 14BL, the rear-center support projection 14BM, and the rear-right support projection 14BR all have substantially rectangular end surfaces. A relay portion 3J connecting the front coil 3F and the rear coil 3B is also called a crossover wire, and is disposed between the eave portion 12h and the projecting portion 52 in the optical-axis direction. In the illustrated example, the coil member 3 is held by the lens holder 2 without using an adhesive, but may be fixed to the lens holder 2 by using an adhesive.

The projecting portion 52 projects radially outward from the outer peripheral surface which is the end of the cylindrical portion 12 on the image sensor IS side (Z2 side). The relay portion 3J of the coil member 3 is disposed on a relay surface 2J formed on the subject side (Z1 side) above the projecting portion 52.

As illustrated in the upper figure of FIG. 5, the lens holder 2 includes two holding portions 72 as rectangular convex projections that project downward (in a Z2 direction) from the surface on the image sensor IS side (Z2 side), six round convex protrusions 2p, and two rectangular convex contact portions 2q. The protrusions 2p may be shaped rectangular convex, and the contact portions 2q may be shaped round convex.

Each of the holding portions 72 is configured such that an extending portion 33, which is a part of the conductive wire constituting the coil member 3, can be wound. In the illustrated example, as illustrated in the lower figure of FIG. 5, the holding portions 72 include a front holding portion 72F corresponding to a portion (front extending portion 33F) on a winding start side of the wire constituting the coil member 3, and a rear holding portion 72B corresponding to a portion (rear extending portion 33B) on a winding end side of the wire constituting the coil member 3. The front extending portion 33F is wound and held by the front holding portion 72F, and the rear extending portion 33B is wound and held by the rear holding portion 72B.

As illustrated in the upper figure of FIG. 5 and an upper figure of FIG. 8, the protrusions 2p include three protrusions 2p corresponding to the left lower plate spring 26L and three protrusions 2p corresponding to the right lower plate spring 26R. An inner portion 26i as a movable-side support portion of the lower plate spring 26 is positioned and fixed to the protrusions 2p. Specifically, the protrusions 2p are inserted into round holes 26k as through-hole portions formed in the inner portion 26i (inner joining portions 26c) of the lower plate spring 26. Each of the through-hole portions may be a hole other than a round hole such as a square hole or an elliptical hole, or may be a notch, as long as it corresponds to the shape of the protrusions 2p.

Next, the driver DM of the lens drive device 101 will be described. As illustrated in the lower figure of FIG. 8, the driver DM includes the coil member 3, the yoke 4, and the two magnets 5 arranged so as to face the front and rear surfaces of the yoke 4. The driver DM generates a driving force (thrust) by the current flowing through the coil member 3 and a magnetic field generated by the magnets 5, and can move the lens holder 2 up and down along the optical-axis direction.

As illustrated in the lower figure of FIG. 5, the coil member 3 is formed by winding a wire (conductive wire) around the outer periphery of the coil support portions 14. Each of the front coil 3F and the rear coil 3B constituting the coil member 3 includes a winding portion 13 as a coil body which is formed by winding a wire in a substantially rectangular annular shape, and an extending portion 33 extending from the winding portion 13 and wound around the holding portion 72. Specifically, the front coil 3F includes a front winding portion 13F and a front extending portion 33F, and the rear coil 3B includes a rear winding portion 13B and a rear extending portion 33B.

In other words, as illustrated in an upper figure of FIG. 6, the extending portions 33 include a front extending portion 33F that extends to a winding-start end 13FS, which is an end of the front winding portion 13F located on an inner periphery side of the front winding portion 13F, and the rear extending portion 33B that extends to a winding end 13BE, which is the end of the rear winding portion 13B located on the outer periphery side of the rear winding portion 13B, as illustrated in an upper figure of FIG. 7.

Specifically, as illustrated in the lower figure of FIG. 5, the front extending portion 33F includes a winding portion 33m wound around the front holding portion 72F, and the rear extending portion 33B includes a winding portion 33m wound around the rear holding portion 72B.

In the illustrated example, the front extending portion 33F is wound around the front holding portion 72F of the lens holder 2 before the wire constituting the front coil 3F is wound around the outer periphery of the front coil support portions 14F, that is, before the front winding portion 13F is formed. In the example as illustrated in the lower figure of FIG. 5, the front extending portion 33F is wound around the front holding portion 72F for four turns. Thus, the winding portion 33m is formed around the front holding portion 72F, and a part of the front extending portion 33F is held by the front holding portion 72F. However, the front extending portion 33F may be wound around the front holding portion 72F after the wire constituting the coil member 3 is wound around the outer periphery of the front coil support portions 14F, that is, after the front winding portion 13F is formed.

After the front extending portion 33F is wound around the front holding portion 72F, the wire constituting the coil member 3 is wound around the outer periphery of the front coil support portions 14F. In this case, as illustrated in the upper figure of FIG. 6, the wire extending from the winding portion 33m extends so as to face a bottom surface of a front recess 2RF, which is a groove formed on a front coil arrangement surface 2CF, and contacts an upper left corner of the front-center support projection 14FM and extends along an upper side of the front-center support projection 14FM.

The front winding portion 13F of the front coil 3F wound around the outer periphery of the front coil support portions 14F is fixed (held) while being supported from the inside by the front-left support projection 14FL, the front-center support projection 14FM, and the front-right support projection 14FR, as illustrated in the lower figure of FIG. 4.

When the wire is wound around the outer periphery of the front coil support portions 14F, as illustrated in the lower figure of FIG. 5, the relay portion 3J that extends to a winding end 13FE of the front winding portion 13F extends to a rear side (X2 side) of the lens holder 2 via the relay surface 2J formed between the eave portion 12h and the projecting portion 52, and extends so as to face a bottom surface of a rear recess 2RB, which is a groove formed in a rear coil arrangement surface 2CB, and extends to a winding-start end 13BS of the rear winding portion 13B, as illustrated in the upper figure of FIG. 7.

Then, the wire constituting the coil member 3 is wound around the outer periphery of the rear coil support portions 14B. At this time, the wire extending from the relay portion 3J contacts the upper surface of the rear-center support projection 14BM and extends toward the rear-left support projection 14BL.

The rear winding portion 13B of the rear coil 3B wound around the outer periphery of the rear coil support portions 14B is fixed (held) while being supported from the inside by the rear-left support projection 14BL, the rear-center support projection 14BM, and the rear-right support projection 14BR, as illustrated in the lower figure of FIG. 5.

When the winding of the wire to the outer periphery of the rear coil support portions 14B is completed, the rear extending portion 33B that extends to the winding end 13BE of the rear winding portion 13B is wound around the rear holding portion 72B, as illustrated in the upper figure of FIG. 7. In the illustrated example, the rear extending portion 33B is wound around the rear holding portion 72B for five turns.

Next, the yoke 4 constituting the driver DM will be described. In the present embodiment, the yoke 4 is made, for example, by applying punching and drawing to a plate made of a soft magnetic material such as iron. Specifically, as illustrated in FIG. 1, the yoke 4 has a bottomless box-shaped outer shape defining a housing portion 4s. The yoke 4 includes a rectangular cylindrical outer wall portion 4A and a flat annular upper surface portion 4B provided so as to be continuous with an upper end (Z1-side end) of the outer wall portion 4A. The yoke 4 thus configured is accommodated in the housing portion 4s by sandwiching the magnets 5 between the outer wall portion 4A and the coil member 3, as illustrated in FIG. 8, and is coupled to the base member 18 to constitute a housing HS together with the base member 18, as illustrated in FIG. 1. However, the yoke 4 may be replaced with a cover member formed of a non-magnetic material such as austenitic stainless steel.

Next, the magnets 5 constituting the driver DM will be described. Each of the magnets 5 has a substantially rectangular parallelepiped shape, as illustrated in FIG. 2. The magnets 5 are positioned outside the coil member 3, as illustrated in the lower figure of FIG. 8, and are arranged so as to face the front and rear surfaces of the rectangular cylindrical outer wall portion 4A constituting the yoke 4. The magnets 5 are fixed to an inner surface of the yoke 4 by an adhesive. The magnets 5 are arranged such that, for example, the upper side (subject side) is the N pole and the lower side is the S pole, or the upper side is the S pole and the lower side is the N pole.

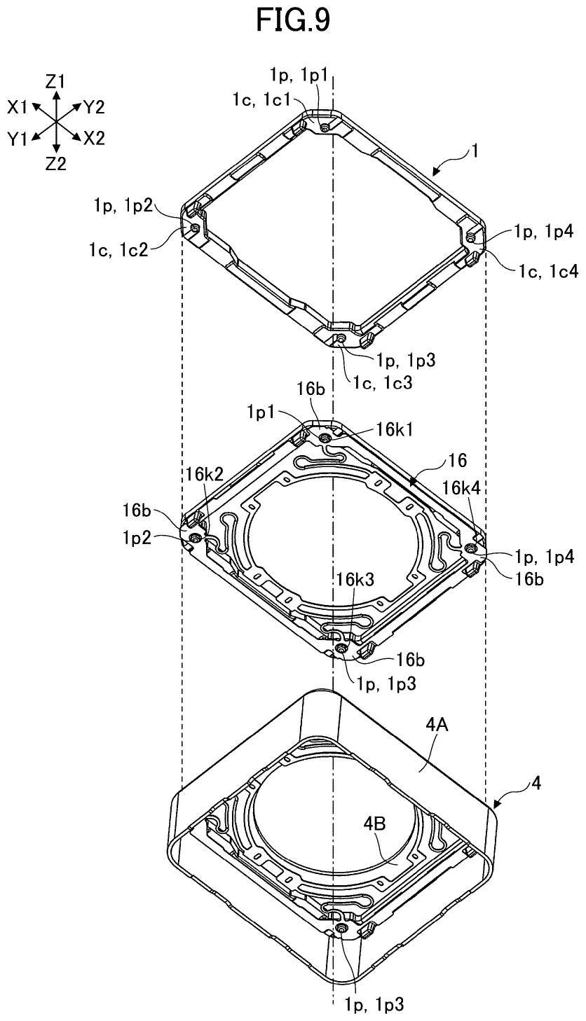

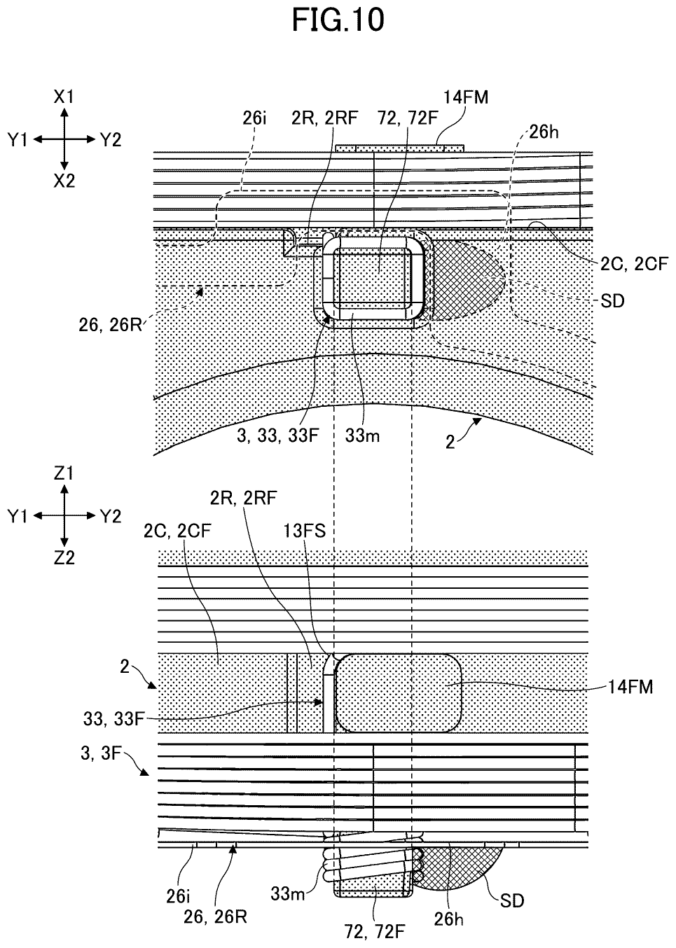

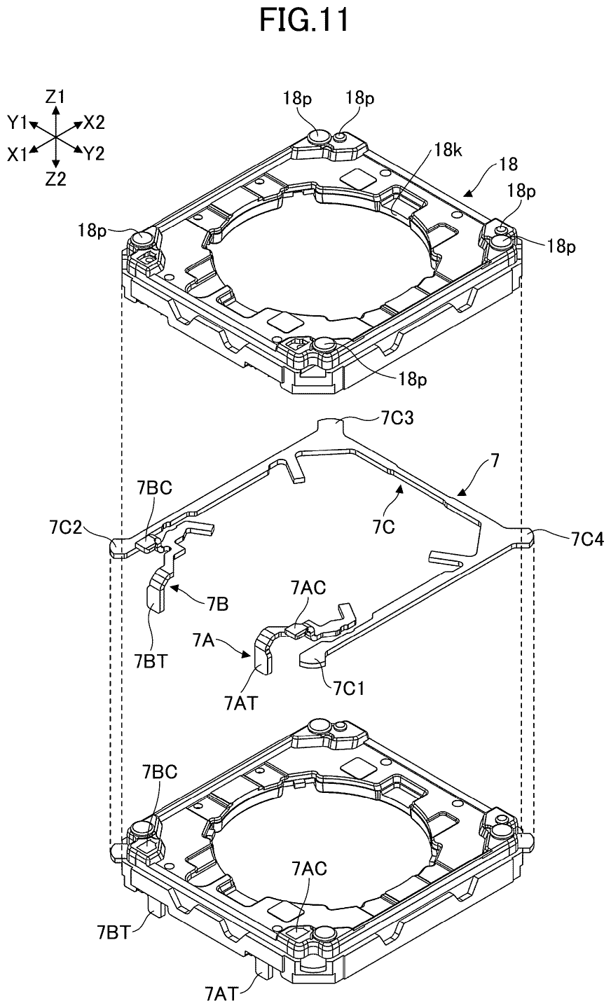

Next, the plate spring 6 and the fixed-side member FB will be described. FIG. 9 is a figure for explaining an example of a connection structure of the three members (plate-spring holder 1, yoke 4, and upper plate spring 16). Specifically, an upper figure of FIG. 9 is a lower perspective view of the plate-spring holder 1. A center figure of FIG. 9 is a lower perspective view of the plate-spring holder 1 and the upper plate spring 16, and a lower figure of FIG. 9 is a lower perspective view of the plate-spring holder 1, the yoke 4, and the upper plate spring 16. FIG. 10 is a figure for explaining an example of the connection structure of the lower plate spring 26 (the right lower plate spring 26R) and the coil member 3 (the front extending portion 33F of the front coil 3F). Specifically, an upper figure of FIG. 10 is an enlarged view of a range R1 enclosed by a broken line in the upper figure of FIG. 8, and a lower figure of FIG. 10 is an enlarged view of the lower plate spring 26 (the right lower plate spring 26R), the coil member 3 (the front coil 3F), and the lens holder 2 when the range R1 is viewed from the X1 side. In FIG. 10, solder SD connecting the front coil 3F and the right lower plate spring 26R is illustrated in a cross pattern. In the upper figure of FIG. 10, the right lower plate spring 26R and the solder SD are illustrated by the broken line in order to make the explanation easier to understand. FIG. 11 is a figure for explaining the base member 18 as the fixed-side member FB. Specifically, an upper figure of FIG. 11 is an upper perspective view of the base member 18, a center figure of FIG. 11 is an upper perspective view of the metal member 7, and a lower figure of FIG. 11 is an upper perspective view of the base member 18 in which the metal member 7 is embedded.

In the present embodiment, the plate spring 6 is made of a metal plate mainly made of copper alloy. The plate spring 6 includes the upper plate spring 16 disposed between the plate-spring holder 1 and the lens holder 2, and the lower plate spring 26 disposed between the lens holder 2 and the base member 18. With the lens holder 2 and the plate spring 6 (the upper plate spring 16, the left lower plate spring 26L, and the right lower plate spring 26R) connected, the plate spring 6 supports the lens holder 2 such that the lens holder 2 can move in the optical-axis direction (Z-axis direction). The lower plate spring 26 (the left lower plate spring 26L and the right lower plate spring 26R) also functions as a power supply member for supplying current to the coil member 3. Therefore, the left lower plate spring 26L is electrically connected to one end of the coil member 3, and the right lower plate spring 26R is electrically connected to the other end of the coil member 3.

As illustrated in the center figure of FIG. 3, the upper plate spring 16 has a substantially rectangular shape in a top view and includes an inner portion 16i as a movable-side support portion fixed to the lens holder 2, an outer portion 16e as a fixed-side support portion fixed to the fixed-side member FB (plate-spring holder 1), and four elastic arms 16g located between the inner portion 16i and the outer portion 16e. Specifically, the inner portion 16i is annularly provided so as to surround the optical axis OA. The outer portion 16e includes four corner portions 16b and four bridges 16r each connecting respective two adjacent corner portions 16b.

In the illustrated example, the upper plate spring 16 is formed so as to have approximate two-fold symmetry around the optical axis OA, and is fixed to the lens holder 2 by the inner portion 16i, and to the plate-spring holder 1 by the outer portion 16e. Therefore, the upper plate spring 16 can support the lens holder 2 in a balanced manner.

When the upper plate spring 16 is attached to the lens holder 2, as illustrated in the center figure of FIG. 3, the inner portion 16i is placed on the pedestal portions 12d of the lens holder 2 (see the lower figure in FIG. 3). Then, as illustrated in the upper figure of FIG. 3, the inner portion 16i and the pedestal portions 12d are joined by an adhesive AD, and thus the inner portion 16i is fixed to the lens holder 2. The outer portion 16e is fixed to the plate-spring holder 1. The plate-spring holder 1 is fixed to the yoke 4 by an adhesive.

The plate-spring holder 1 is configured to hold the upper plate spring 16 inside the yoke 4. Specifically, as illustrated in the upper figure of FIG. 9, the plate-spring holder 1 has substantially a rectangular annular shape and includes four corners 1c (first corner 1c1 to fourth corner 1c4) and four projections 1p (first projection 1p1 to fourth projection 1p4) projecting downward (in the Z2 direction) from each of the four corners 1c. As illustrated in the center figure of FIG. 9, the four projections 1p are inserted into four round holes 16k (first round hole 16k1 to fourth round hole 16k4) as through-holes formed in the four corner portions 16b of the upper plate spring 16.

More specifically, as illustrated in the center figure of FIG. 9, the first projection 1p1 is inserted into the first round hole 16k1 formed in the upper plate spring 16, the second projection 1p2 is inserted into the second round hole 16k2, the third projection 1p3 is inserted into the third round hole 16k3, and the fourth projection 1p4 is inserted into the fourth round hole 16k4.

Then, the four projections 1p of the plate-spring holder 1 and the four corner portions 16b of the upper plate spring 16 are joined by an adhesive. The joining of the four projections 1p of the plate-spring holder 1 and the four corner portions 16b of the upper plate spring 16 may be achieved by applying hot or cold caulking to the projections 1p. The plate-spring holder 1 is configured to allow elastic deformation of the elastic arms 16g constituting the upper plate spring 16.

As illustrated in the upper figure of FIG. 8, the left lower plate spring 26L and the right lower plate spring 26R are formed to be substantially symmetrical to each other, and the shapes of the inner portions (the sides facing the optical axis OA) thereof are substantially semicircular. Each of the left lower plate spring 26L and the right lower plate spring 26R includes the inner portion 26i as a movable-side support portion fixed to the lens holder 2, an outer portion 26e as a fixed-side support portion fixed to the fixed-side member FB (base member 18), and two elastic arm portions 26g located between the inner portion 26i and the outer portion 26e.

As illustrated in the upper figure of FIG. 8, each inner portion 26i of the left lower plate spring 26L and the right lower plate spring 26R includes two inner joining portions 26c joined to the lens holder 2, and a connecting plate portion 26h facing the extending portion 33 of the coil member 3.

When the left lower plate spring 26L and the right lower plate spring 26R are attached to the lens holder 2, each of the six protrusions 2p of the lens holder 2 illustrated in the upper figure of FIG. 5 is inserted into the corresponding round hole 26k as a through-hole portion provided in the inner joining portions 26c of the left lower plate spring 26L and the right lower plate spring 26R illustrated in the upper figure of FIG. 8. The round hole 26k as a through-hole portion may be a notch. Thus, each inner portion 26i of the left lower plate spring 26L and the right lower plate spring 26R is positioned and fixed to the lens holder 2. The left lower plate spring 26L and the right lower plate spring 26R are fixed to the lens holder 2, for example, by applying hot or cold caulking to the protrusions 2p of the lens holder 2.

As illustrated in the upper figure of FIG. 10, when the right lower plate spring 26R is attached to the lens holder 2, the connecting plate portion 26h of the inner portion 26i included in the right lower plate spring 26R faces the surface on the image sensor IS side (Z2 side) of the lens holder 2. That is, the surface on the subject side (Z1 side) of the connecting plate portion 26h faces the surface on the image sensor IS side (Z2 side) of the lens holder 2. As illustrated in the lower figure of FIG. 10, the front extending portion 33F constituting the coil member 3 extends along the Z-axis direction so as to face the bottom surface of the front recess 2RF formed on the front coil arrangement surface 2CF.

When the right lower plate spring 26R is attached to the lens holder 2, as illustrated in the lower figure of FIG. 10, the front holding portion 72F projects downward (in the Z2 direction) from the inner portion 26i so that the tip thereof is located on the image sensor IS side (Z2 side) than the inner portion 26i of the right lower plate spring 26R. A part of the winding portion 33m is also wound around the front holding portion 72F so as to be located on the image sensor IS side (Z2 side) than the inner portion 26i.

The right lower plate spring 26R and the winding portion 33m of the coil member 3 are electrically and mechanically connected with each other by solder SD. Specifically, as illustrated in the upper figure of FIG. 8, the right lower plate spring 26R is attached to the lens holder 2 such that the round holes 26k formed in the inner joining portions 26c and the protrusions 2p of the lens holder 2 are fitted together. The protrusions 2p of the lens holder 2 are thermally caulked, and a solder paste applied to the connecting plate portion 26h is heated by laser light. However, the right lower plate spring 26R and the front extending portion 33F of the coil member 3 may be electrically and mechanically connected with each other by a conductive adhesive in which conductive fillers such as silver particles are dispersed in a synthetic resin. The above description with reference to FIG. 10 similarly applies to the connection of the left lower plate spring 26L, the lens holder 2, and the rear coil 3B.

As illustrated in the upper figure of FIG. 8, the outer portion 26e of the left lower plate spring 26L includes two outer joining portions 26d joined to the base member 18. Similarly, the outer portion 26e of the right lower plate spring 26R includes two outer joining portions 26d joined to the base member 18.

The base member 18 is made by injection molding by using, for example, a synthetic resin such as liquid crystal polymer. In the present embodiment, as illustrated in FIG. 11, the base member 18 is a member having a substantially rectangular plate-like outer shape, and a circular opening 18k is formed in the center. In addition, six projections 18p projecting upward are provided on the surface on the subject side (Z1 side) of the base member 18. The projections 18p are inserted and fitted into the through holes 26t (see the upper figure in FIG. 8) provided in the outer joining portions 26d in the left lower plate spring 26L and the right lower plate spring 26R. At this time, the projections 18p are thermally caulked and fixed to the outer joining portions 26d. In FIG. 11, the projections 18p are illustrated in a state where the tips thereof are deformed after being thermally caulked. The projections 18p may be cold-caulked and fixed to the outer joining portions 26d.

As illustrated in FIG. 11, a metal member 7 formed of a metal plate containing a material such as copper, iron, or an alloy mainly composed thereof is insert molded and embedded in the base member 18.

The metal member 7 includes a first metal member 7A to a third metal member 7C. The first metal member 7A includes a connecting portion 7AC exposed from an upper surface (Z1-side surface) of the base member 18, and a second metal member 7B includes a connecting portion 7BC exposed from the upper surface (Z1-side surface) of the base member 18. In the illustrated example, a surface of the connecting portion 7AC and a surface of the connecting portion 7BC are located on the same plane.

The connecting portion 7AC is connected to a corresponding one of the outer joining portions 26d of the right lower plate spring 26R by laser welding or with a conductive bonding material, while facing a through hole 26dt (see the upper drawing in FIG. 8) formed in the outer joining portion 26d of the right lower plate spring 26R. The conductive bonding material is, for example, solder or a conductive adhesive.

Similarly, the connecting portion 7BC is connected to the other outer joining portion 26d of the left lower plate spring 26L by laser welding or with a conductive bonding material, while facing the through hole 26dt (see the upper drawing in FIG. 8) formed in the outer joining portion 26d of the left lower plate spring 26L.

The first metal member 7A includes a terminal portion 7AT projecting downward from a bottom surface (Z2-side surface) of the base member 18, and the second metal member 7B includes a terminal portion 7BT projecting downward from the bottom surface (Z2-side surface) of the base member 18.

The third metal member 7C includes end portions 7C1 to 7C4 projecting outward in the direction perpendicular to the optical-axis direction from corners of the base member 18. Each of the end portions 7C1 to 7C4 is configured to contact lower end portions of four corners of the yoke 4, as illustrated in FIG. 1.

The base member 18 is fixed to the yoke 4 by welding each of the end portions 7C1 to 7C4 and the lower end portions of the four corners of the yoke 4 after being positioned by combining the inner surface of the outer wall portion 4A of the yoke 4 with the outer peripheral side surface of the base member 18. The yoke 4 and the base member 18 may be fixed at least partially by an adhesive.

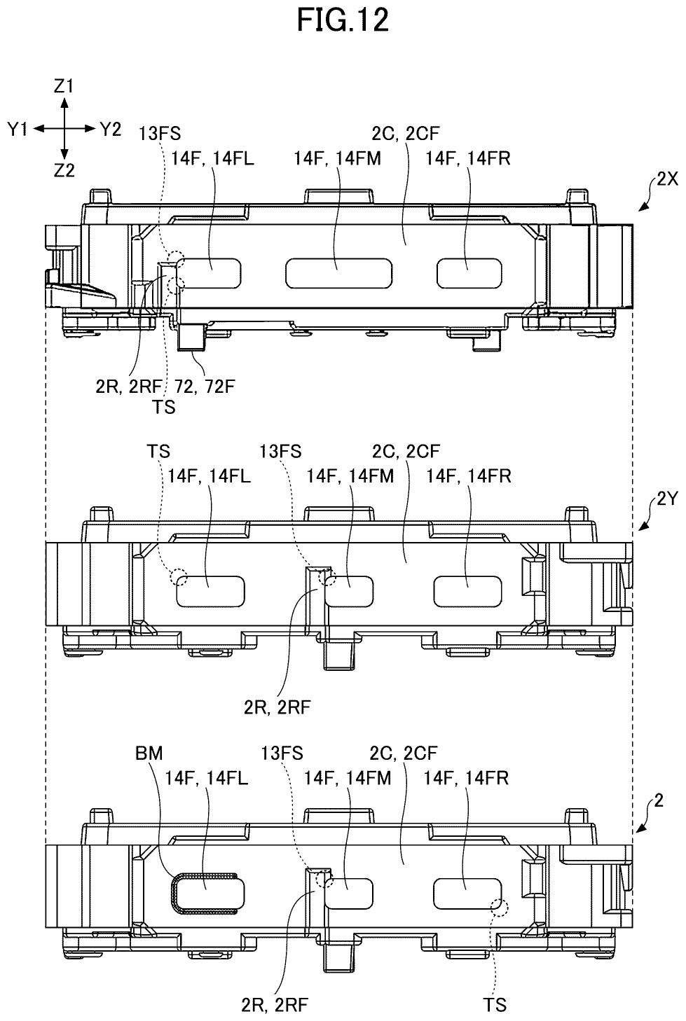

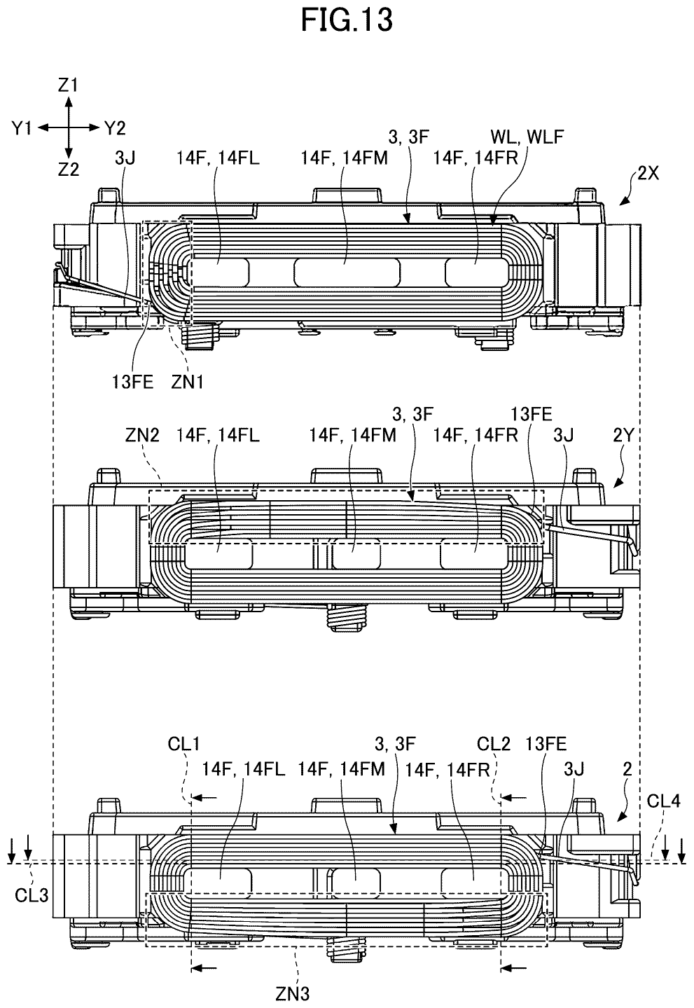

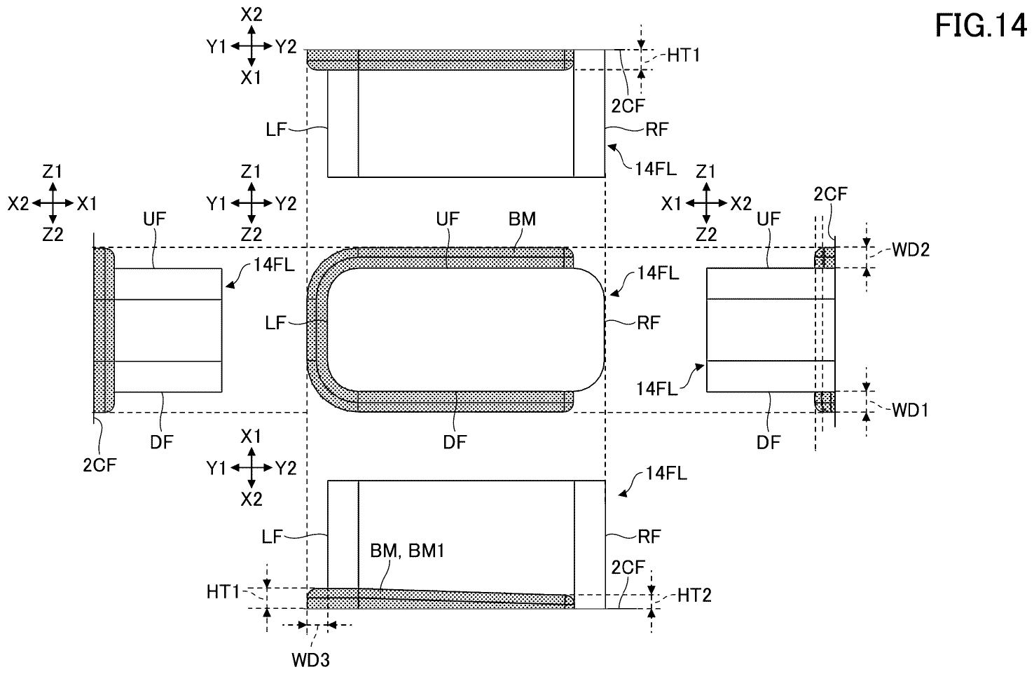

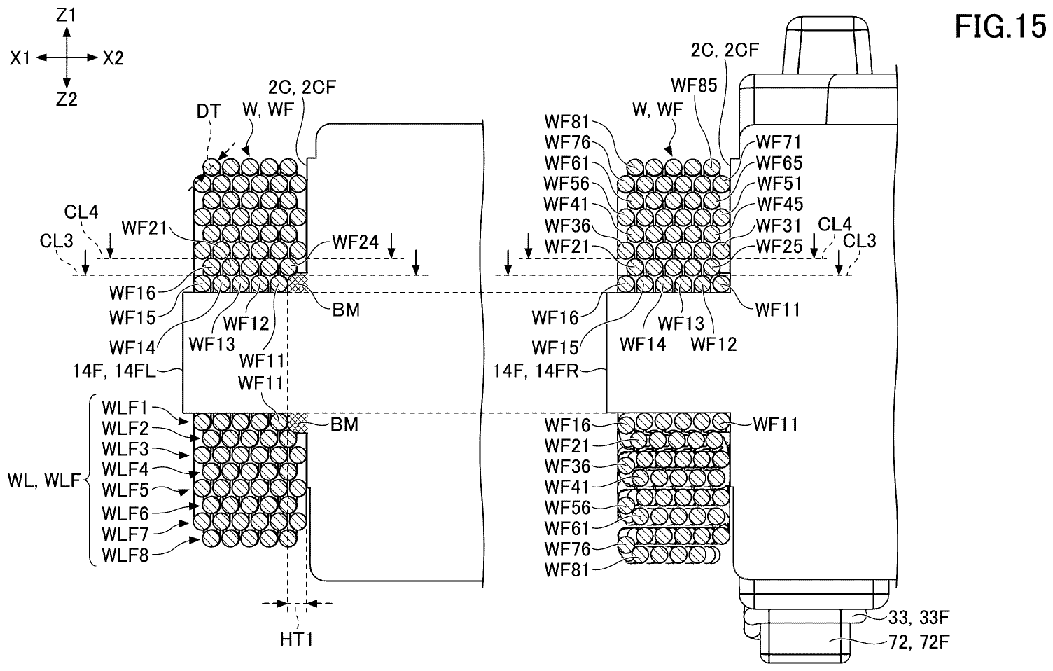

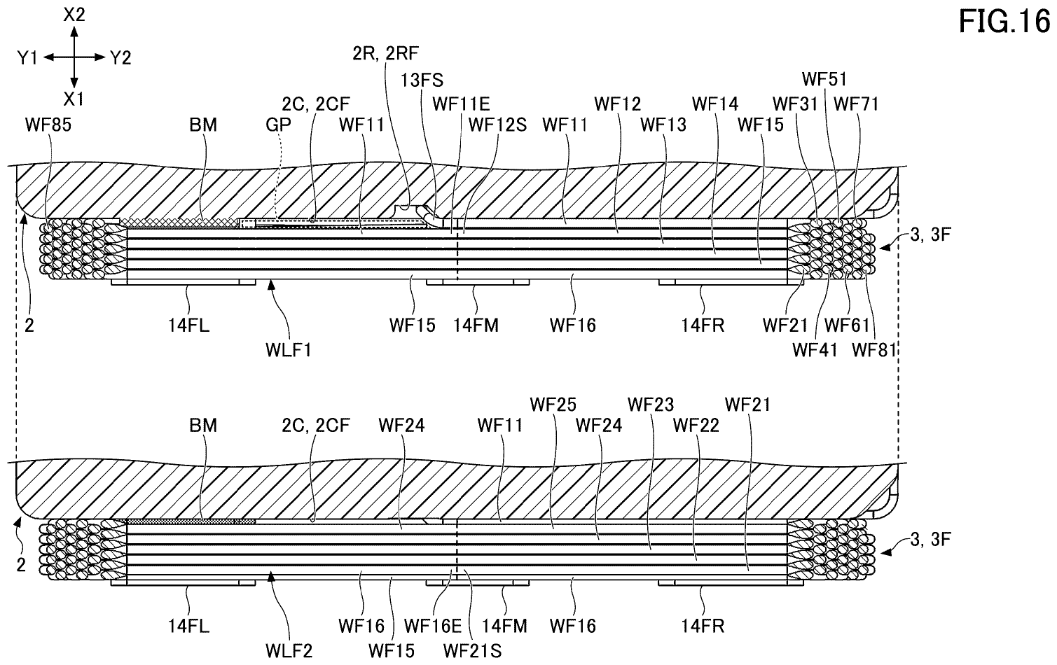

Next, the positional relationship between the lens holder 2 and the coil member 3 will be described with reference to FIGS. 12 to 16. FIG. 12 is front views of lens holders 2, 2X, and 2Y. Specifically, an upper figure of FIG. 12 is a front view of the lens holder 2X as a comparative example, a center figure of FIG. 12 is a front view of the lens holder 2Y as another comparative example, and a lower figure of FIG. 12 is a front view of the lens holder 2 according to the embodiment of the present disclosure. FIG. 13 is front views of the lens holders 2, 2X, and 2Y each wound with the coil member 3. Specifically, an upper figure of FIG. 13 is the front view of the lens holder 2X wound with the coil member 3, a center figure of FIG. 13 is the front view of the lens holder 2Y wound with the coil member 3, and a lower figure of FIG. 13 is the front view of the lens holder 2 wound with the coil member 3. FIG. 14 is a front view, a left side view, a right side view, a top view, and a bottom view of the front-left support projection 14FL constituting the front coil support portions 14F. FIGS. 15 and 16 are partial cross-sectional views of the lens holder 2 and the coil member 3. Specifically, a left figure of FIG. 15 illustrates a cross section of the lens holder 2 and the coil member 3 viewed from the Y2 side in an imaginary plane parallel to an XZ plane including a cutting line CL1 in the lower figure of FIG. 13. A right figure of FIG. 15 illustrates a cross section of the lens holder 2 and the coil member 3 viewed from the Y2 side in an imaginary plane parallel to an XZ plane including a cutting line CL2 in the lower figure of FIG. 13. An upper figure of FIG. 16 illustrates a cross section of the lens holder 2 and the coil member 3 viewed from the Z1 side in an imaginary plane parallel to the XY plane including a cutting line CL3 in the lower figure of FIG. 13. The lower figure of FIG. 16 illustrates a cross section of the lens holder 2 and the coil member 3 viewed from the Z1 side in an imaginary plane parallel to the XY plane including a cutting line CL4 in the lower figure of FIG. 13.

In the present embodiment, the wire constituting the coil member 3 includes a conductive metal wire and an insulating covering layer covering the metal wire. The covering layer has a two-layer structure including an insulating layer covering the metal wire and a fusing layer arranged around the insulating layer. When the coil member 3 is wound around the outer periphery of the coil support portions 14, two annular wire portions W adjacent to each other have their fusing layers thermally fused to each other. In FIGS. 13, 15, and 16, the covering layer is not illustrated for clarity.

The coil member 3 (front coil 3F) wound around the coil support portions 14 (front coil support portions 14F) of the lens holder 2 includes eight winding layers WL (front winding layers WLF) as illustrated in FIG. 15. The eight front winding layers WLF include a first layer WLF1 to an eighth layer WLF8. The first layer WLF1 includes a 6-turn front annular wire portion WF (a first front annular wire portion WF11 to a sixth front annular wire portion WF16), a second layer WLF2 includes a 5-turn front annular wire portion WF (a first front annular wire portion WF21 to a fifth front annular wire portion WF25), a third layer WLF3 includes a 6-turn front annular wire portion WF (a first front annular wire portion WF31 to a sixth front annular wire portion WF36), a fourth layer WLF4 includes a 5-turn front annular wire portion WF (a first front annular wire portion WF41 to a fifth front annular wire portion WF45), a fifth layer WLF5 includes a 6-turn front annular wire portion WF (a first front annular wire portion WF51 to a sixth front annular wire portion WF56), and a sixth layer WLF6 includes a 5-turn front annular wire portion WF (a first front annular wire portion WF61 to a fifth front annular wire portion WF65), a seventh layer WLF7 includes a 6-turn front annular wire portion WF (a first front annular wire portion WF71 to a sixth front annular wire portion WF76), and the eighth layer WLF8 includes a 5-turn front annular wire portion WF (a first front annular wire portion WF81 to a fifth front annular wire portion WF85). The same applies to the lens holder 2X as a comparative example and the coil member 3 (front coil 3F) wound around the lens holder 2Y as another comparative example.

As illustrated in the upper figure of FIG. 12, the lens holder 2X as a comparative example includes a front recess 2RF on the Y1 side of the front-left support projection 14FL, and the wire constituting the front coil 3F forms a winding-start end 13FS at the upper left corner of the front-left support projection 14FL, is wound clockwise around the front coil support portions 14F in a front view, and forms an inclination start portion TS at a lower left corner of the front-left support projection 14FL. The inclination start portion TS is the portion where inclination of the wire for transition from the first turn (the first front annular wire portion WF11) to the second turn (the second front annular wire portion WF12) of the first layer WLF1 starts.

With this configuration, the wire wound around the lens holder 2X is wound around the front coil support portions 14F so as to be displaced to the X1 side as it extends from the Z2 side to the Z1 side within a range ZN1 surrounded by a dashed line, as illustrated in the upper figure of FIG. 13. Therefore, in the range ZN1, which is the range corresponding to a short side on the left side of the front coil 3F, the wire constituting the front coil 3F is difficult to be wound while aligned, and there is a risk of causing winding disorder. Specifically, in the transition part for transition from the first turn (the first front annular wire portion WF11) to the second turn (the second front annular wire portion WF12) of the first layer WLF1, which is the innermost layer of the eight winding layers WL, a space is formed between the first front annular wire portion WF11 and the front coil arrangement surface 2CF, and another front annular wire portion WF (for example, the fifth front annular wire portion WF25 of the second layer WLF2) enters into this space, which may cause winding disorder of the wire constituting the front coil 3F. In addition, since the relay portion 3J of the wire constituting the front coil 3F is drawn out at the relay portion 3J from within the range ZN1 which is the range including the winding end 13FE of the front coil 3F, winding disorder is prone to occur at this point, and there is a risk that the relay portion 3J may become loose.

As illustrated in the center figure of FIG. 12, the lens holder 2Y as another comparative example includes a front recess 2RF on the Y1 side of the front-center support projection 14FM, and the wire constituting the front coil 3F form a winding-start end 13FS at the upper left corner of the front-center support projection 14FM, is wound clockwise around the front coil support portions 14F in a front view, and form an inclination start portion TS at the upper left corner of the front-left support projection 14FL.

As illustrated in the center figure of FIG. 13, the wire wound around the lens holder 2Y is wound around the front coil support portions 14F in a range ZN2 surrounded by a broken line such that the wire is displaced to the X1 side as the wire extends from the Y1 side to the Y2 side. Therefore, the wire constituting the front coil 3F has difficulty in aligning and winding in the range ZN2 corresponding to an upper long side of the front coil 3F, and there is a risk of causing winding disorder. Specifically, in a transition part for transition from the first turn (first front annular wire portion WF11) to the second turn (second front annular wire portion WF12) of the first layer WLF1, which is the innermost layer of the eight winding layers WL, a space is formed between the first front annular wire portion WF11 and the front coil arrangement surface 2CF, and there is a risk of causing winding disorder in the wire constituting the front coil 3F when another front annular wire portion WF (for example, the fifth front annular wire portion WF25 of the second layer WLF2) enters the space. In addition, since the relay portion 3J of the wire constituting the front coil 3F is drawn out from the range ZN2 which is the range including the winding end 13FE of the front coil 3F, winding disorder may easily occur in this respect as well, and there is a risk of loosening the relay portion 3J.

Therefore, the lens holder 2 according to the embodiment of the present disclosure includes a protruding portion BM at a base of the front-left support projection 14FL, as illustrated in the lower figure of FIG. 12, such that the occurrence of winding disorder of the wire constituting the front coil 3F can be suppressed. That is, the lens holder 2 is configured such that the aligned winding of the wire constituting the front coil 3F can be easily achieved even within a range ZN3, which is the range that corresponds to a range along the lower long side of the front coil 3F, such that the occurrence of winding disorder can be suppressed. Specifically, as illustrated in a lower figure of FIG. 6, at a position corresponding to a transition part TR for transition from the first turn (the first front annular wire portion WF11) to the second turn (the second front annular wire portion WF12) of the first layer WLF1, which is the innermost layer of the eight winding layers WL, the protruding portion BM is arranged so as to fill a space GP between the first front annular wire portion WF11 and the front coil arrangement surface 2CF, such that no other front annular wire portions WF (for example, the fifth front annular wire portion WF25 of the second layer WLF2) enter the space GP and thus occurrence of winding disorder of the wire constituting the front coil 3F can be suppressed. In the lower figures of FIG. 6, FIG. 12, FIG. 14, and FIG. 16, a dotted pattern is applied to surfaces of the protruding portion BM for clarity. In the upper figures of FIG. 15 and FIG. 16, a cross pattern is applied to cross sections of the protruding portion BM for clarity.

More specifically, as illustrated in the lower figure of FIG. 12, the lens holder 2 includes a front recess 2RF on the Y1 side of the front-center support projection 14FM, and is configured such that the wire constituting the front coil 3F form a winding-start end 13FS at the upper left corner of the front-center support projection 14FM, is wound clockwise around the front coil support portions 14F in a front view, and form an inclination start portion TS at a lower right corner of the front-right support projection 14FR. That is, as illustrated in the lower figure of FIG. 6, the first front annular wire portion WF11 constituting the first layer WLF1 of the front coil 3F is arranged such that the right end is positioned on the X1 side of the front coil arrangement surface 2CF, and the left end is positioned on the X1 side of the protruding portion BM. Therefore, the first front annular wire portion WF11 is wound around the front coil support portions 14F such that it is displaced to the X1 side as it extends from the Y2 side to the Y1 side.

With this configuration, the wire constituting the front coil 3F is wound around the front coil support portions 14F so as to be displaced to the X1 side as it extends from the Y2 side to the Y1 side in a state where at least a part of the space GP between the first front annular wire portion WF11 and the front coil arrangement surface 2CF is filled by the protruding portion BM in the range ZN3 surrounded by the broken line in the lower figure of FIG. 13, as illustrated in the lower figure of FIG. 6. Therefore, with this configuration, it is possible to suppress the occurrence of winding disorder of the wire due to another front annular wire portion WF (for example, the fifth front annular wire portion WF25 of the second layer WLF2) entering the space GP between the first front annular wire portion WF11 and the front coil arrangement surface 2CF. Moreover, since the relay portion 3J of the wire constituting the front coil 3F is not drawn out from the range ZN3, winding disorder is unlikely to occur in this respect as well, and loosening of the relay portion 3J is also unlikely to occur.

The details of the protruding portion BM will now be described with reference to FIG. 14. As illustrated in FIG. 14, the protruding portion BM is provided at the base of an upper surface UF, a left surface LF, and a lower surface DF of the front-left support projection 14FL. In the illustrated example, the protruding portion BM is provided so as to have a width WD1 and a height HT1 at the base of the lower surface DF, a width WD2 and the height HT1 at the base of the upper surface UF, a width WD3 and the height HT1 at the base of the left surface LF, and is not provided at the base of the right surface RF. The height HT1 is approximately the same as a thickness DT of one wire rod, and the widths WD1, WD2, and WD3 are all approximately the same as the thickness DT of one wire rod. A lower portion BM1 of the protruding portion BM, which is provided at the base of the lower surface DF, is formed so as to gradually increase from the end on the Y2 side toward the end on the Y1 side. That is, the lower portion BM1 is formed so as to have a maximum height HT1 at the end on the Y1 side and a minimum height HT2 at the end on the Y2 side.

As illustrated in FIG. 15, the wire constituting the front coil 3F is wound around the front coil support portions 14F so as to form the eight winding layers WL (front winding layers WLF). Specifically, the front coil 3F is configured such that each of the odd-numbered layers, that are the first layer WLF1, the third layer WLF3, the fifth layer WLF5, and the seventh layer WLF7 includes six front annular wire portions WF, and each of the even-numbered layers, that are the second layer WLF2, the fourth layer WLF4, the sixth layer WLF6, and the eighth layer WLF8 includes five front annular wire portions WF.

In addition, as illustrated in the upper figure of FIG. 16, the first layer WLF1 of the wire constituting the front coil 3F is configured so as to achieve the aligned winding of the six front annular wire portions WF (the first front annular wire portion WF11 to the sixth front annular wire portion WF16) on the Z1 side of the front coil support portions 14F. Specifically, the first layer WLF1 of the wire constituting the front coil 3F is configured such that an end point WF11E of the first front annular wire portion WF11 and a start point WF12S of the second front annular wire portion WF12 are connected on the Z1 side of the front-center support projection 14FM. The same applies to the connection between an end point of the second front annular wire portion WF12 and a start point of the third front annular wire portion WF13, and the like.

In addition, as illustrated in the lower figure of FIG. 16, the second layer WLF2 of the wire constituting the front coil 3F is configured so as to achieve the aligned winding of the five front annular wire portions WF (the first front annular wire portion WF21 to the fifth front annular wire portion WF25) on the Z1 side of the front coil support portions 14F. Specifically, the second layer WLF2 of the wire constituting the front coil 3F is configured such that an end point WF16E of the sixth front annular wire portion WF16 of the first layer WLF1 and a start point WF21S of the first front annular wire portion WF21 of the second layer WLF2 are connected on the Z1 side of the front-center support projection 14FM. The same applies to the connection between an end point of the first front annular wire portion WF21 of the second layer WLF2 and a start point of a second front annular wire portion WF22 of the second layer WLF2, and the like.

This configuration stabilizes the shape of the front coil 3F and brings about an effect that winding disorder is unlikely to occur.

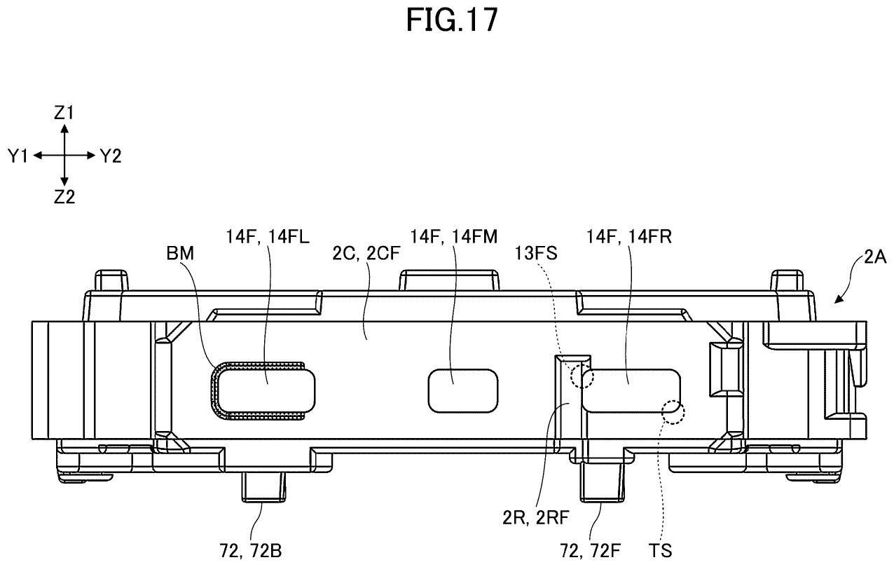

Next, referring to FIG. 17, the lens holder 2A, which is another configuration example of the lens holder 2, will be described. FIG. 17 is a front view of the lens holder 2A, and corresponds to the lower figure of FIG. 12, which is the front view of the lens holder 2.

The lens holder 2A differs from the lens holder 2 in which the front recess 2RF is formed on the Y1 side of the front-right support projection 14FR on the front coil arrangement surface 2CF, in the point that the front recess 2RF is formed on the Y1 side of the front-center support projection 14FM.

Specifically, the lens holder 2A is configured such that the wire constituting the front coil 3F form a winding-start end 13FS at the upper left corner of the front-right support projection 14FR, is wound clockwise around the front coil support portions 14F in a front view, and forms an inclination start portion TS at the lower right corner of the front-right support projection 14FR. That is, as in the case of the lens holder 2, the first front annular wire portion WF11 constituting the first layer WLF1 of the front coil 3F is, as illustrated in the lower figure of FIG. 6, arranged such that the right end thereof is positioned on an X1-side surface of the front coil arrangement surface 2CF, while the left end thereof is positioned on an X1-side surface of the protruding portion BM. Therefore, the first front annular wire portion WF11 is wound around the front coil support portions 14F such that it is displaced to the X1 side as it extends from the Y2 side to the Y1 side.

With this configuration, the wire wound around the lens holder 2A can suppress the occurrence of winding disorder of the wire constituting the front coil 3F as in the case of the lens holder 2. Moreover, since the relay portion 3J is not drawn out from the transition part TR, winding disorder of the wire constituting the front coil 3F is unlikely to occur, and also, loosening of the relay portion 3J is unlikely to occur.

As described above, the lens drive device 101 according to the present embodiment includes, as illustrated in FIG. 2: the lens holder 2 having the cylindrical portion 12 capable of holding the lens body LS; the support (plate spring 6) for supporting the lens holder 2 movably in the optical-axis direction; the coil member 3 provided in the lens holder 2 and having a first coil (front coil 3F), a second coil (rear coil 3B), and the relay portion 3J for connecting the first coil (front coil 3F) and the second coil (rear coil 3B) in series and formed of continuous wire (conductive wire); and a first magnet (front magnet 5F) facing the first coil (front coil 3F) and a second magnet (rear magnet 5B) facing the second coil (rear coil 3B). The lens holder 2 includes: a first holding portion (front holding portion 72F) which is provided on one end side (Z1 side) of the cylindrical portion 12 in the optical-axis direction and holds one end of the wire and a second holding portion (rear holding portion 72B) which holds the other end; a first coil arrangement surface (front coil arrangement surface 2CF) which is provided on one of the two outer surfaces facing each other across the optical axis OA and on which the first coil (front coil 3F) is arranged; a second coil arrangement surface (rear coil arrangement surface 2CB) which is provided on the other of the two outer surfaces facing each other across the optical axis OA and on which the second coil (rear coil 3B) is arranged; and a relay surface 2J which is located between the first coil arrangement surface (front coil arrangement surface 2CF) and the second coil arrangement surface (rear coil arrangement surface 2CB) and faces the relay portion 3J; first coil support portions (front coil support portions 14F) around which a first annular wire portion (front annular wire portion WF) projecting outward (X1 side) from a first coil arrangement surface (front coil arrangement surface 2CF) and constituting the first coil (front coil 3F) is wound, and second coil support portions (rear coil support portions 14B) around which a second annular wire portion (rear annular wire portion WB) projecting outward (X2 side) from a second coil arrangement surface (rear coil arrangement surface 2CB) and constituting the second coil (rear coil 3B) is wound. As illustrated in FIG. 6, the first coil support portions (front coil support portions 14F) include a first support projection (front-right support projection 14FR), a second support projection (front-left support projection 14FL), and an intermediate support projection (front-center support projection 14FM) located between the first support projection (front-right support projection 14FR) and the second support projection (front-left support projection 14FL), that are arranged side by side apart from each other in an extending direction (Y-axis direction) of the first annular wire portion (front annular wire portion WF) perpendicular to the optical-axis direction. The first coil (front coil 3F) is wound around the first coil support portions (front coil support portions 14F) with a portion where a wire (front extending portion 33F) extending from the first holding portion (front holding portion 72F) is bent to one side (Y2 side which is away from the second support projection (front-left support projection 14FL)) in the extending direction (Y-axis direction) at the first support projection (front-right support projection 14FR) or the intermediate support projection (front-center support projection 14FM) as the winding-start end 13FS of the first turn (first front annular wire portion WF11 which is the first winding), and a base of the second support projection (front-left support projection 14FL) is provided with a protruding portion BM positioned on an extension line EL of the first annular wire portion (first annular wire portion WF11) extending from the winding-start end 13FS of the first turn (first annular wire portion WF11).

This configuration brings about an effect that the wire constituting the coil member 3 is less likely to generate winding disorder. This is because, at a position corresponding to the transition part TR for transition from the first turn to the second turn, the protruding portion BM is provided so as to fill the space GP between the annular wire portion (the first front annular wire portion WF11) of the first turn and the lens holder 2 (coil arrangement surface 2C), such that the annular wire portion (the first front annular wire portion WF11) of the first turn can be prevented from moving in an axial direction (X-axis direction) of a coil axis and entering of another annular wire portion WF (for example, the front annular wire portion WF constituting the second layer WLF2) into the space GP can be suppressed. Therefore, this configuration brings about an effect of suppressing the wire constituting the coil member 3 from contacting other nearby members and preventing a distance between the coil member 3 and the magnet 5 from becoming uneven.

In addition, the protruding portion BM preferably contacts the first coil arrangement surface (front coil arrangement surface 2CF) and the second support projection (front-left support projection 14FL), as illustrated in the left figure of FIG. 15. A projection amount (height HT1) of the protruding portion BM (the portion located on the extension line EL) projecting from the first coil arrangement surface (front coil arrangement surface 2CF) toward the X1 side is preferably approximately the same as the thickness DT of one wire rod.

As illustrated in the upper figure of FIG. 16, this configuration brings about an effect that the end point WF11E of the first front annular wire portion WF11 of the first turn supported by the second support projection (front-left support projection 14FL) can be aligned with the start point WF12S of the second front annular wire portion WF12 of the second turn supported by the intermediate support projection (front-center support projection 14FM).

Furthermore, as illustrated in FIG. 14, the protruding portion BM is preferably provided at the base of a first surface (lower surface DF) located on one end side (Z2 side) in the optical-axis direction (Z-axis direction), a second surface (upper surface UF) located on the other end side (Z1 side) in the optical-axis direction (Z-axis direction), and a third surface (left surface LF) located on a distal side (Y1 side) with respect to the intermediate support projection (front-center support projection 14FM), of the second support projection (front-left support projection 14FL).

This configuration brings about an effect that occurrence of winding disorder of the wire constituting the coil member 3 can be further reduced. This is because the space GP formed between the first front annular wire portion WF11 and the lens holder 2 (front coil arrangement surface 2CF) of the first turn can be reduced, as illustrated in the lower figure of FIG. 6. In addition, this configuration allows the transition part TR for transition from the first turn to the second turn of the wire constituting the front coil 3F to be formed in the range ZN3 that corresponds to the range along the lower long side of the front coil 3F, and thus brings about an effect that the winding disorder of the wire which may occur in the transition part TR can be suppressed from affecting loosening of the relay portion 3J that extends from the upper right corner of the first support projection (front-right support projection 14FR) toward the second coil (rear coil 3B).

In addition, as illustrated in FIG. 14, the projection amount (width WD1 to width WD3) of the protruding portion BM protruding from the first surface (lower surface DF), the second surface (upper surface UF), and the third surface (left surface LF) of the second support projection (front-left support projection 14FL) is preferably approximately the same as the thickness DT of one wire rod. Furthermore, the projection amount (height HT1) of the protruding portion BM from the first coil arrangement surface (front coil arrangement surface 2CF) on the first surface (lower surface DF) is preferably approximately the same as the thickness DT of the wire at a position near the third surface (left surface LF), and is smaller than the thickness DT of the wire at a position away from the third surface (left surface LF). In the illustrated example, the projection amount (height HT1) is the minimum value (height HT2) at a position away from the third surface (left surface LF). In addition, a part of the first front annular wire portion WF11 of the first turn is located on the outside (X1 side) of the protruding portion BM, as illustrated in the lower figure in FIG. 6.

This configuration brings about an effect that the space GP formed between the first front annular wire portion WF11 of the first turn and the lens holder 2 (front coil arrangement surface 2CF) can be reduced, as illustrated in the lower figure in FIG. 6.

In addition, the protruding portion BM on the first surface (lower surface DF) preferably includes a portion (lower portion BM1) in which the projection amount (height HT1) from the first coil arrangement surface (front coil arrangement surface 2CF) changes in a continuous manner, as illustrated in FIG. 14.

This configuration brings about an effect that machining of the protruding portion BM becomes easier as compared to a case in which the protruding portion BM is formed in a step-like shape. In addition, this configuration has the effect that the stability of the wire support by the protruding portion BM can be enhanced.

In addition, the relay portion 3J is preferably arranged so as to extend toward the second coil (rear coil 3B) from the winding end 13FE of the first coil (front coil 3F) located at the end of one side (Y2 side) of the first coil (front coil 3F) in the extending direction (Y-axis direction), as illustrated in the lower figure of FIG. 8.

In this configuration, as compared with the case where the lens holder 2Y illustrated in the center figure of FIG. 13 is used, as illustrated in the lower figure of FIG. 13, the length of the wire between the range (range ZN3) where the transition part TR for transition from the first turn to the second turn is located and the relay portion 3J can be increased. Therefore, even when a winding disorder occurs in the range ZN3 where the transition part TR is located, the influence is less likely to reach the relay portion 3J, and the occurrence of loosening of the relay portion 3J can be suppressed.

In addition, the first coil (front coil 3F) is preferably wound around the first coil support portions (front coil support portions 14F) with a portion where the first annular wire portion (first front annular wire portion WF11) is bent to one side (Y2 side) in the extending direction (Y-axis direction) of the intermediate support projection (front-center support projection 14FM) as the winding-start end 13FS of the first turn.

In this configuration, as compared with the case where the first coil (front coil 3F) is wound around the first coil support portions (front coil support portions 14F) with the portion where the first annular wire portion (first front annular wire portion WF11) is bent to one side (Y2 side) in the extending direction (Y-axis direction) of the first support projection (front-right support projection 14FR) as the winding-start end 13FS of the first turn, occurrence of the winding disorder of the wire constituting the first coil (front coil 3F) can be further reduced. This is because the space GP formed between the first annular wire portion WF11 and the lens holder 2 (front coil arrangement surface 2CF) of the first turn can be further reduced. For example, the space formed on the Z1 side of the intermediate support projection (front-center support projection 14FM) can be eliminated.

The lens drive device described above can suppress winding disorder of the wire constituting the coil (first coil).

The preferred embodiment of the present invention has been described in detail above. However, the present invention is not limited to the above-described embodiment. The above-described embodiment can be modified and replaced without departing from the scope of the present invention. Each of the features described with reference to the above-described embodiment may be appropriately combined as long as there is no technical contradiction.

For example, in the above-described embodiment, the number of intermediate support projections (front-center support projection 14FM) is one, but two or more may be provided.

In the above-described embodiment, the protruding portion BM is not provided at the base of a lower surface of the intermediate support projection (front-center support projection 14FM), but may be provided at the base of the lower surface of the intermediate support projections (front-center support projection 14FM). In this case, the protruding portion provided at the base of the lower surface of the intermediate support projection (front-center support projection 14FM) is preferably formed such that the amount of projection (height) in the axial direction (X-axis direction) of the coil axis changes in a continuous manner. When the winding-start end 13FS of the first turn is formed at the upper left corner of the first support projection (front-right support projection 14FR), the protruding portion BM may be provided at the base of an upper surface of the intermediate support projection (front-center support projection 14FM) in addition to the base of the second support projection (front-left support projection 14FL).

What is claimed is:

1. A lens drive device, comprising:
a lens holder capable of holding a lens body;
a support configured to movably support the lens holder in an optical-axis direction;
a coil member provided in the lens holder and formed of continuous wire including a first coil, a second coil, and a relay portion serially connecting the first coil and the second coil; and
a first magnet facing the first coil and a second magnet facing the second coil, wherein
the lens holder includes:
a first holding portion provided on one end side in the optical-axis direction, and configured to hold one end portion of the wire;
a second holding portion configured to hold another end portion of the wire;
a first coil arrangement surface provided on one surface of two outer surfaces of the lens holder facing each other across an optical axis;
a second coil arrangement surface provided on another surface of the two outer surfaces;
a relay surface provided between the first coil arrangement surface and the second coil arrangement surface and facing the relay portion;
first coil support portions projecting outwardly from the first coil arrangement surface and wound with a first annular wire portion constituting the first coil; and
second coil support portions projecting outwardly from the second coil arrangement surface and wound with a second annular wire portion constituting the second coil,
the first coil support portions include:
a first support projection;
a second support projection; and
an intermediate support projection provided between the first support projection and the second support projection, which are arranged side by side apart from each other in an extending direction perpendicular to the optical-axis direction of the first annular wire portion,
the first coil is wound around the first coil support portions with a portion where the wire extending from the first holding portion is bent to one side in the extending direction at the first support projection or the intermediate support projection as a winding-start end of a first turn, and
a base of the second support projection is provided with a protruding portion located on an extension line of the first annular wire portion extending from the winding-start end of the first turn.

2. The lens drive device according to claim 1, wherein
the protruding portion contacts the first coil arrangement surface and the second support projection, and
a projection amount of the protruding portion projecting from the first coil arrangement surface is approximately same as a thickness of the wire.

3. The lens drive device according to claim 2, wherein
the protruding portion is provided at a base of a first surface positioned on one side in the optical-axis direction, a second surface located on another side in the optical-axis direction, and a third surface located on a distal side with respect to the intermediate support projection, of the second support projection.

4. The lens drive device according to claim 3, wherein
a projection amount of the protruding portion projecting from the first surface, the second surface, and the third surface, in the second support projection, is approximately same as the thickness of the wire, and
a projection amount of the protruding portion on the first surface from the first coil arrangement surface is approximately the same as the thickness of the wire at a position near the third surface, and is smaller than the thickness of the wire at a position away from the third surface.

5. The lens drive device according to claim 4, wherein
the protruding portion arranged on the first surface includes a portion in which the projection amount from the first coil arrangement surface changes in a continuous manner.

6. The lens drive device according to claim 1, wherein
the relay portion is arranged so as to extend toward the second coil from a winding end of the first coil located at an end on one side of the first coil in the extending direction.

7. The lens drive device according to claim 1, wherein
in the first coil, the first annular wire portion is wound around the first coil support portions with a portion bent to one side in the extending direction at the intermediate support projection as the winding-start end of the first turn.

8. A camera module, comprising:
the lens drive device of claim 1;
the lens body; and
an image sensor facing the lens body.
